(19) United States
(12) Patent Application Publication
(10) Pub. No.: US 2018/0098380 A1
(43) Pub. Date: Apr. 5, 2018

(54) Auto Warm-Up Device for Metal Musical Wind Instruments

(71) Applicant: Gregory Sylvester Bannister, Vista, CA (US)

(72) Inventor: Gregory Sylvester Bannister, Vista, CA (US)

(21) Appl. No.: 15/652,450

(22) Filed: Jul. 18, 2017

Related U.S. Application Data
(60) Provisional application No. 62/493,796, filed on Jul. 18, 2016.

(51) Int. Cl. H05B 1/02; G10G 7/00

(52) U.S. Cl. CPC H05B 1/0227; G10G 7/00

(57) ABSTRACT

A device to automatically heat a metal musical wind instrument, while in its case, to the optimal operational temperature is provided. This automatic warm up device consists of a heating element, heating control unit, charging module, bluetooth enabled handheld wireless user interface, and an instrument sleeve accessory. The heating element is temperature sensitive and provides an indication of the internal temperature of the interior storage compartment to the heating control unit. The heating control unit consists of a thermostat, heating circuit, and re-chargeable battery. The thermostat receives the internal temperature information from the heating element and maintains the set temperature via the heating circuit, to increase the temperature (turn ON the Heating element) or decrease the temperature (turn Off the Heating element). The charging module allows battery charging from all modes of operation where an external power source is present: 120V, USB, or 12V car lighter. The instrument sleeve accessory can be employed to maintain the optimal operating temperature of the instrument when the instrument is on its stand during breaks while performing or practicing. The Auto Warm Up Device is not designed to be employed while the instrumentalist is actively performing or practicing on the instrument.

This device can be employed as a portable device, available to be moved from one instrument case to another, or installed as an integral part of the instrument case. The design provides for customized heating elements sized for specific instruments and instrument cases.

### BACKGROUND

### Field of the Invention

The present invention relates to warming up any metal wind musical instrument in preparation for performance or practice by the instrumentalist. Specifically the invention automatically heats the metal wind instrument to the desired optimum operating temperature while in the closed instrument case, negating the customary habit of manually warming up the metal wind instrument to tile optimum operating temperature prior to performance or practice on the instrument.

### Description of the Prior Art

The use of musical instrument heating is known in the prior art. More specifically, musical instrument heating has focused on outdoor applications to protect the instrument mouthpiece from harsh weather conditions, such as cold temperatures [Peterson-U.S. Pat. No. 4,742,755], and a musical instrument warmer for outdoor applications below freezing temperatures utilizing a shroud and heating element [Ashwood-U.S. Pat. No. 5,920,022]. Other prior art focused on heating the instrument during idle periods when it is not being played by installing a heater in the instrument stand to maintain the instrument at normal operating temperature when not in use [Smith-U.S. Pat. No. 4,926,735]; and for maintaining multiple instruments at normal operating temperature when the instrument is not in use [Smith-U.S. Pat. No. 5,253,563]. Heating has also been employed in storage and protection of a musical instrument via a heated case, usually employed for wood musical instruments [Gunsberg-US Patent 2010/0264048 A1].

There has been no focus on the preparatory “Warm Up” phase of metal wind instrumentalists, where achieving the optimum operating temperature of the horn is the priority, before performance quality issues like responsiveness, optimal tonal quality, intonation, vibrato, fluent technique and optimal breathing, can be addressed. The Auto Warm-Up (AWUP) device for Metal Musical Wind Instruments provides a unique solution to the preparatory “Warm-Up” activities for intermediate and advanced students, as well as semi-professional and professional metal wind instrumentalists, that has not been addressed in the prior art.

A metal woodwind instrument, such as a saxophone, or a brass wind instrument, such as a trumpet, trombone, tuba, or French horn, for example, must be prepared for performance by assembling the instrument and blowing long legato tones through it, utilizing the musician's warm airflow to raise the metal wind instrument temperature to the optimal performance temperature. This is typically referred to as the “Warm Up” phase in preparation for practice or performance. This is necessary because a “cold” instrument is unresponsive, has poor tonal quality, and is difficult to play, as compared with a “warmed up” instrument. The resonating frequency of the metal instrument is raised as the temperature of the air passing through it warms it, thus moving the instrument to the optimal performance temperature (i.e. optimal resonating frequency).

This “Warm Up” phase is applicable to all levels of musicianship: beginner, intermediate, advanced, or professional. This portion of the warm up process is typically 70-80% of the total warm up time, which can vary from 15 to 45 minutes, depending on the initial instrument temperature and instrument size. The other 20-30% of the warm up process is devoted to reed break-in and embouchure exercises targeting responsiveness, optimal tonal quality, intonation, vibrato, fluent technique and optimal breathing.

### SUMMARY

An auto warm-up (AWUP) device to prepare a metal wind instrument for optimal performance is provided. The AWUP device is designed to bring the metal wind instrument to its optimal performance temperature while in the instrument case. This automatic warm-up device consists of a heating element, heating control unit, charging module, a Bluetooth enabled wireless handheld user interface and an instrument sleeve accessory.

### BRIEF DESCRIPTION OF THE DRAWINGS

FIG. 1 is a System Block Diagram displaying the high level component configuration of the Auto Warm-Up Device.

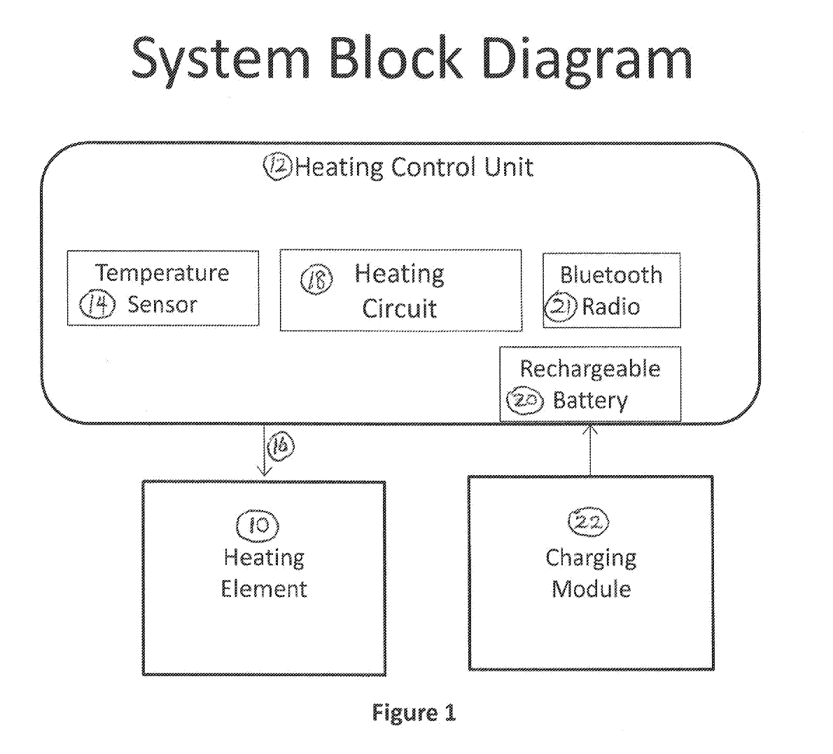

FIG. 2 is a Functional Flow Diagram providing a step-by-step flow diagram of the Auto Warm-Up Device through its operational states.

FIG. 3 is a representation of the Auto Warm-Up Device from an end product perspective, for a saxophone. It includes the Heating element for the instrument in a closed case use case and the instrument sleeve accessory for the instrument resting on the stand use case. Note that this is an example only. The Auto Warm-Up Device is intended for all metal wind instruments, which include woodwinds with metal instrument bodies, as well as brass wind instruments.

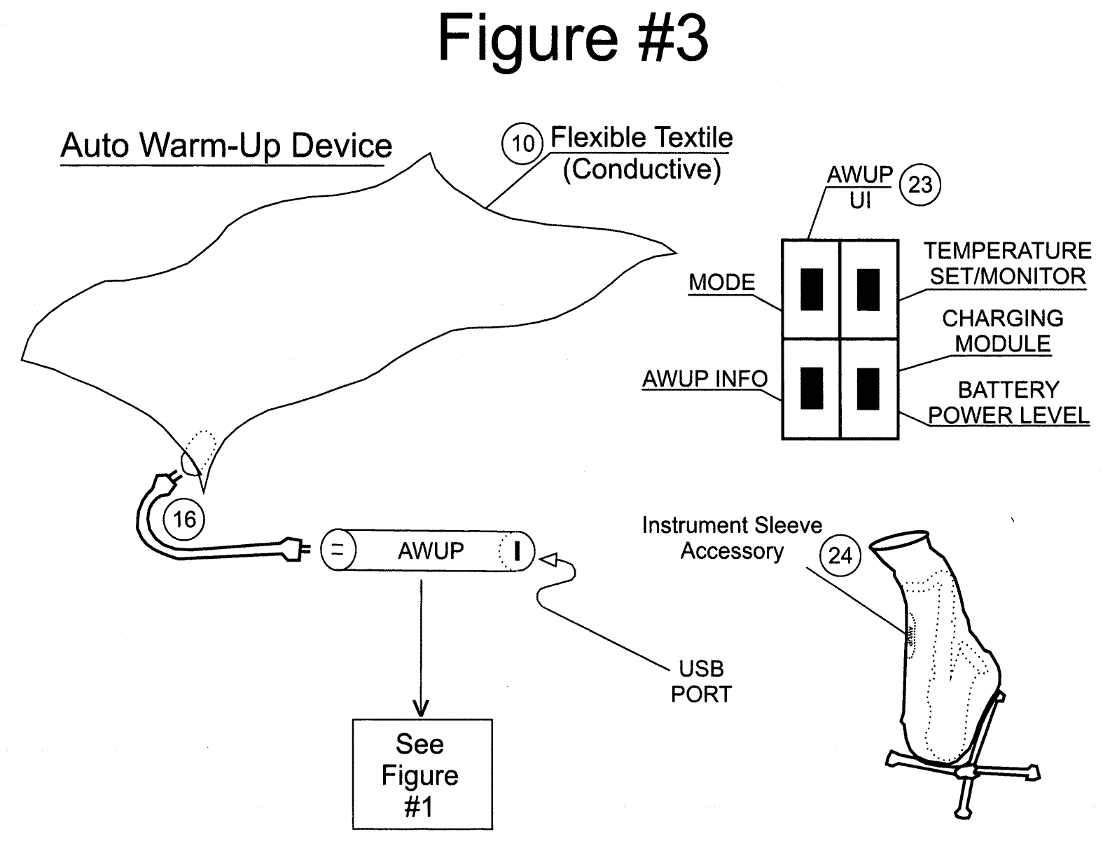

FIG. 4 is a representation of the Auto Warm-Up Device installed in a saxophone case as it is to be used with the case closed, for example. The Bluetooth enabled handheld wireless User Interface monitors and controls the Auto Warm-Up Device operational modes per the table in the following Detailed Description section.

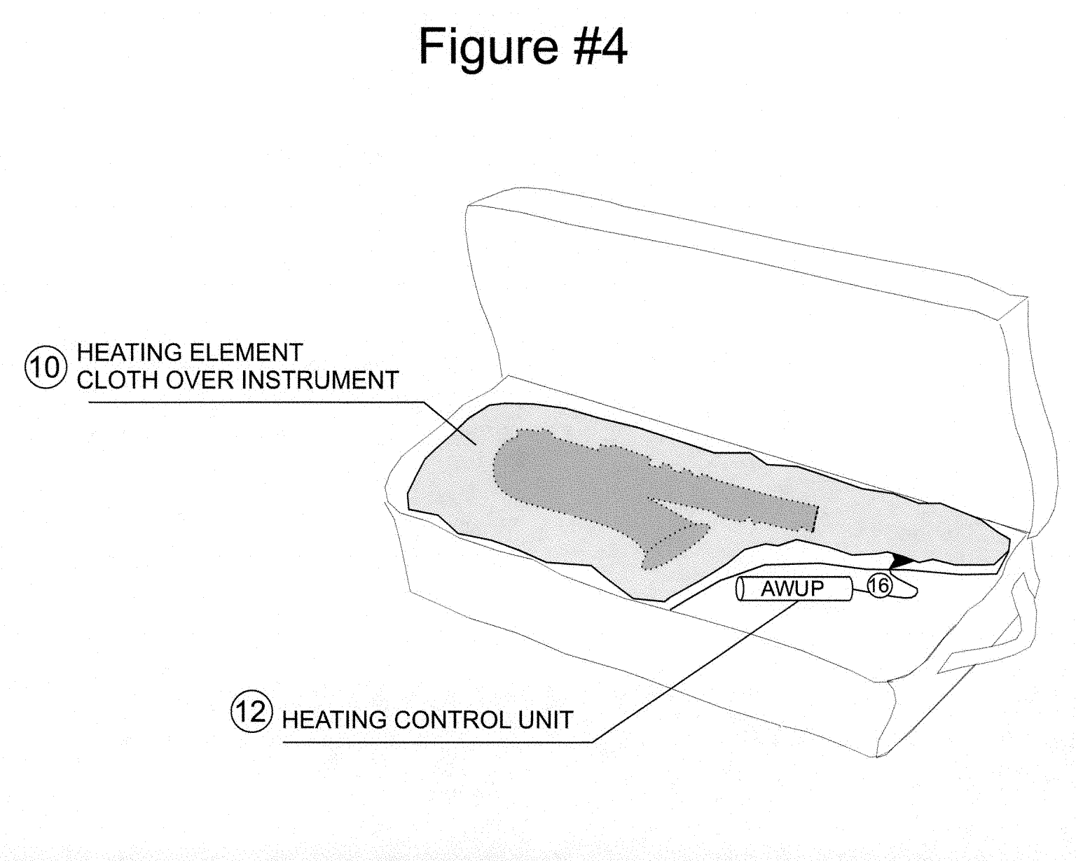

NOTE: The case in FIG. 4 is shown as open for illustrative purposes, but the operational mode specifies the case to be closed.

FIG. 5 is a representation of the instrument sleeve being utilized with the Auto Warm-Up Device to maintain the optimal operating temperature during a performance or practice session break.

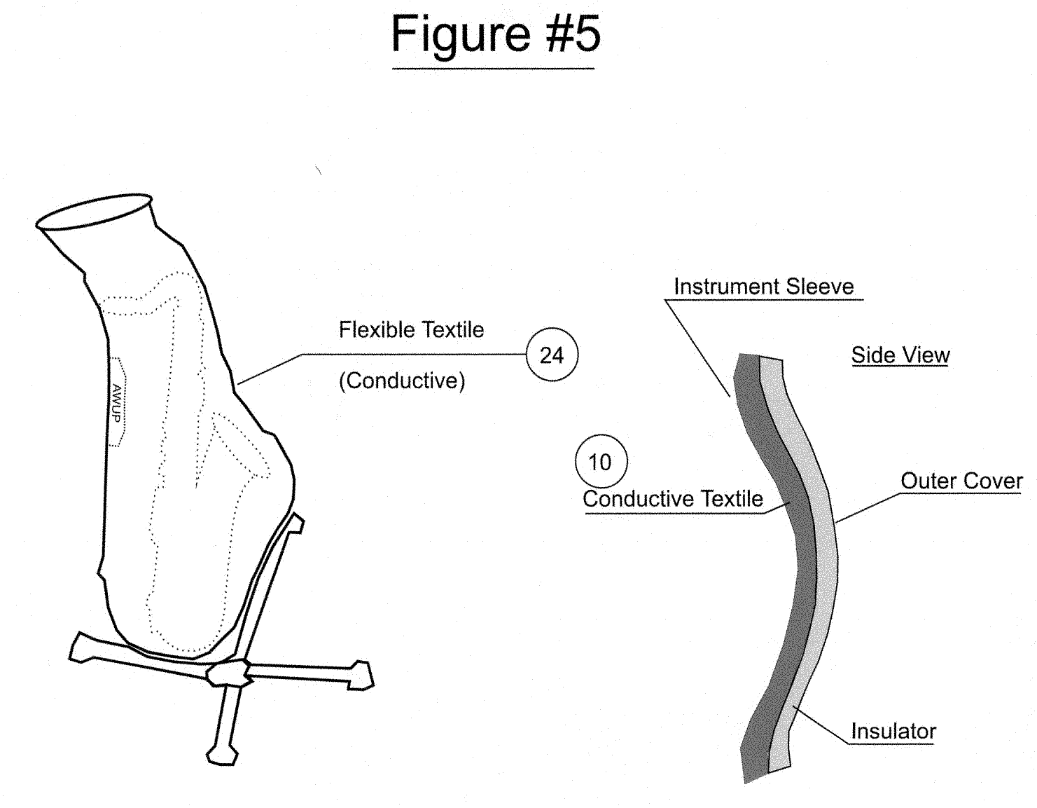

### DETAILED DESCRIPTION

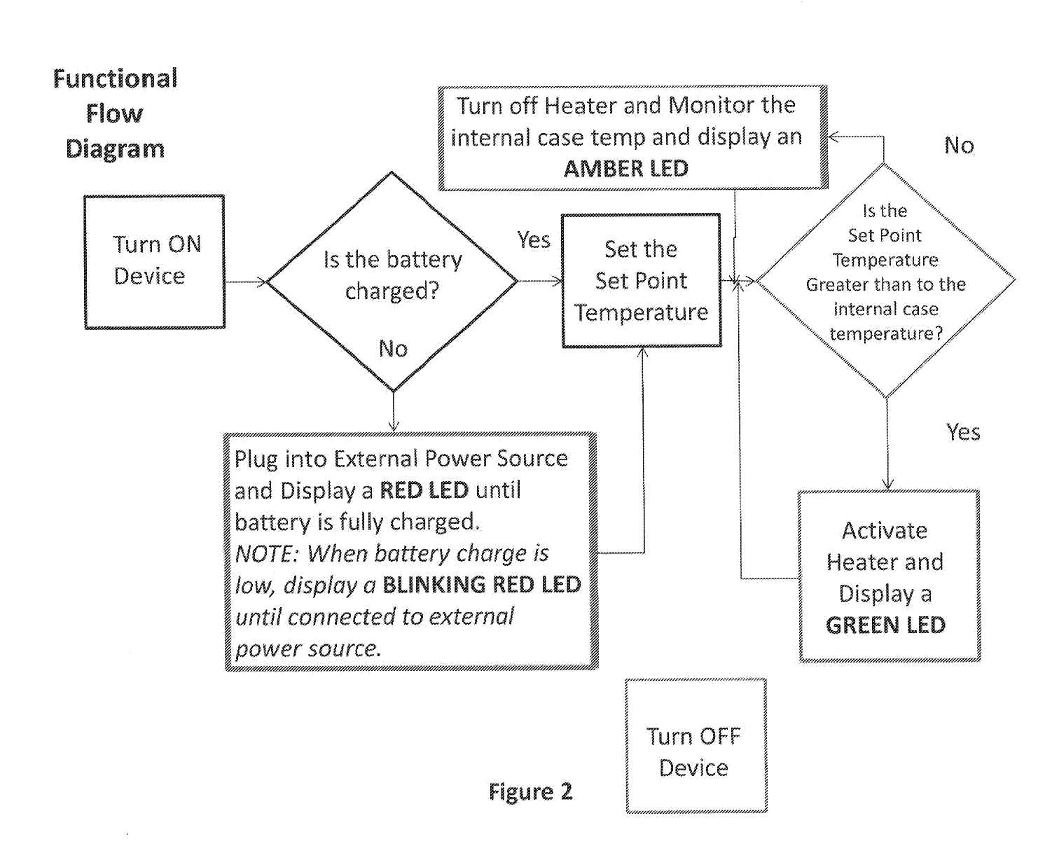

A device to automatically heat a metal musical wind instrument, while in its case, to the optimal operational temperature is provided. This automatic warm-up (AWUP) device consists of a heating element 10, heating element connector 16, heating control unit 12, and a charging module 22. The heating element 10 provides heat to the instrument case cavity when actuated by the heating control unit 12. The heating control unit 12 consists of a heating element connector 16, temperature sensor 14, heating circuit 18, Bluetooth radio 21, and rechargeable battery 20. It controls and maintains the heating function of the device. The heating control unit 12 receives the internal temperature information from the temp sensor 14, which provides the current interior case compartment temperature to the heating control unit for comparison to the set point temperature, maintaining the set temperature via the heating circuit 18, increasing the temperature (turn ON the Heating element) or decreasing the temperature (turn OFF the Heating element) See FIG. 2. The charging module 22 allows battery charging from all modes of operation where an external power source is present: 120V, USB, or 12V car lighter. When no external power supply is present, the device uses the internal rechargeable battery 20 for its power source.

The heating element 10 is a conductive textile material that is positioned in the cavity of the case where the instrument fits, or it can be attached to the case padding that touches the instrument. If the interior temperature is below the set point temperature, the heating circuit 18 initiates heating up to the set point temperature. If the interior temperature is above the set point temperature, the heating circuit 18 turns off heating to reduce the temperature to the set point temperature. Ideally the set point temperature will be in a range that provides the optimal performance temperature of the instrument. The set temperature can be set within a range from 90° F. to 105° F.

The rechargeable battery 20 is the power source for the heating control unit. It also connects directly to the charging module 22, which is capable of charging the battery from three possible sources: 120V source (electrical outlet), USB source (car, computer, etc.), or 12V source (car lighter socket).

A bluetooth enabled handheld wireless user interface 23 is provided to control the Auto Warm-Up Device functionality. This Bluetooth enabled handheld wireless user interface 23 monitors and sets the current mode of operation; monitors the internal case temperature and controls the set point temperature; monitors and controls the charging module; and provides all system and subsystem info for the Auto Warm Up Device. The operational modes and their functions are shown in the table below:

| LED | STATE | FUNCTION |
|---|---|---|
| GREEN | AUTO WARM UP | HEATING MODE |
| | DEVICE IS | |
| | OPERATING | |
| AMBER | AUTO WARM UP | MAINTAIN SET TEMP MODE |
| | DEVICE IS ON | |
| | STANDBY | |
| RED | BATTERY IS | CHARGING FROM |
| | RE-CHARGING | EXTERNAL POWER |
| | | SOURCE |
| BLINKING | BATTERY CHARGE | NEEDS CHARGE FROM |
| RED | IS LOW | EXTERNAL SOURCE |

What is claimed:

1. An electrical device that heats and maintains a metal wind musical instrument at its optimal operating temperature while in its case, prior to removal by the instrumentalist for practice or performance, the device comprising :
A temperature sensor 14 residing in the instrument case to provide the storage compartment environment temperature;
A power source—internal: re-chargeable battery 20 or external: electrical outlet, automobile lighter unit, USB power socket, to supply electrical power
a heat control unit 12 located in the interior of the metal wind musical instrument case to receive power from the power source, to receive an indication of the temperature from the temperature sensor 14, to obtain a determination of whether the temperature in the metal wind instrument case is at the pre-determined temperature set point, and to generate a drive signal if the temperature is below the set point;
A heating element 10, which is located in the canal of the metal wind instrument case, consisting of a conductive textile fabric, to receive the drive signal from the heat control unit 12 and heat the interior metal wind musical instrument case environment based on the drive signal, up to the set point temperature.

2. The metal wind musical instrument electrical device of claim 1, further including a Bluetooth enabled handheld wireless user interface 23 linked to the heating control unit to allow a user to monitor and control the desired operational mode of the device.

3. The metal wind musical instrument electrical device of claim 2, wherein the bluetooth enabled handheld wireless user interface 23 provides a notification indicating the remaining amount of power stored in the rechargeable battery.

4. The metal wind musical instrument electrical device of claim 1, further includes an electrical plug (110V) cord connected to the device via a male USB connector for insertion into an electrical outlet, the electrical plug providing an electrical connection between the electrical outlet and the internal charging module 22 when the electrical plug is inserted into the electrical outlet.

5. The metal wind musical instrument electrical device of claim 1, further includes an automobile 12V cigarette lighter plug connected to the device via a male USB connector for insertion into an automobile 12V cigarette lighter socket, the automobile 12V cigarette lighter plug providing an electrical connection between the automobile 12V cigarette lighter socket and the internal charging module 22 when the automobile 12V cigarette lighter plug is inserted into the automobile 12V cigarette lighter socket.

6. The metal wind musical instrument electrical device of claim 1, further includes a male USB connector connected to the device via a male USB connector for insertion into an automobile USB power socket, the male USB connector providing an electrical connection between the automobile USB power socket and the internal charging module 22 when the male USB connector is inserted into the automobile USB power socket.

7. The metal wind musical instrument electrical device of claim 1, further includes an instrument sleeve accessory 24 that enables the Auto Warm-Up (AWUP) Device to operate when the instrument is mounted on its stand. The instrument sleeve accessory 24 fits over the instrument on the stand, contains its own heating element and connects to the Auto Warm Up Device, providing complete functionality while the instrument is on the stand.
